(19) United States
(12) Patent Application Publication
(10) Pub. No.: US 2005/0170700 A1
(43) Pub. Date: Aug. 4, 2005

(54) High speed electrical connector without ground contacts

(76) Inventors: Joseph B. Shuey, Camp Hill, PA (US); Stephen B. Smith, Mechanicsburg, PA (US)

Correspondence Address: WOODCOCK WASHBURN, LLP, ONE LIBERTY PLACE - 46TH FLOOR, PHILADELPHIA, PA, 19103, US

(21) Appl. No.: 10/917,994

(22) Filed: Aug. 13, 2004

Related U.S. Application Data
(63) Continuation-in-part of application No. 10/294,966, filed on Nov. 14, 2002.
Application No. 10/294,966 is a continuation-in-part of application No. 09/990,794, filed on Nov. 14, 2001, now Pat. No. 6,692,272.
Application No. 10/294,966 is a continuation-in-part of application No. 10/155,786, filed on May 24, 2002, now Pat. No. 6,652,318.

(51) Int. Cl. H01R 13/502

(52) U.S. Cl. 439/701

(57) ABSTRACT

A high speed electrical connector is disclosed. The electrical connector includes a first set of a plurality of differential signal pairs arranged in a first linear array and a second set of a plurality differential signal pairs arranged in a second linear array adjacent to the first linear array. Further, the electrical connector is devoid of a ground contact between the first linear array of differential signal pairs and the second linear array of differential signal pairs.

### CROSS-REFERENCE TO RELATED APPLICATIONS

This application is a continuation-in-part of co-pending U.S. patent application Ser. No. 10/294,966, filed Nov. 14, 2002, which is a continuation-in-part of U.S. patent application Ser. No. 09/990,794, filed Nov. 14, 2001, now U.S. Pat. No. 6,692,272, and U.S. Ser. No. 10/155,786, filed May 24, 2002, now U.S. Pat. No. 6,652,318.

The subject matter disclosed and claimed herein is related to the subject matter disclosed and claimed in U.S. patent application no. [attorney docket FCI-2759 (C3630)], filed on even date herewith, and entitled “High speed differential transmission structures without grounds.”

The contents of each of the above-referenced U.S. patents and patent applications is herein incorporated by reference in its entirety.

### FIELD OF THE INVENTION

Generally, the invention relates to the field of electrical connectors. More particularly, the invention relates to lightweight, low cost, high density electrical connectors that provide impedance controlled, high speed, low interference communications, even in the absence of ground contacts in the connector.

### BACKGROUND OF THE INVENTION

Electrical connectors provide signal connections between electronic devices using signal contacts. Often, the signal contacts are so closely spaced that undesirable interference, or “cross talk,” occurs between adjacent signal contacts. Cross talk occurs when a signal on one signal contact induces electrical interference in an adjacent signal contact due to intermingling electrical fields, thereby compromising signal integrity. With electronic device miniaturization and high speed, high signal integrity electronic communications becoming more prevalent, the reduction of noise becomes a significant factor in connector design.

One method used in the prior art to reduce the effects of cross talk is the use of ground contacts within the contact arrangement in the connector. Specifically, electrical connectors are designed to include ground contacts adjacent and/or between the signal contacts in the connector. Such ground contacts help to prevent unwanted cross talk such that the signal integrity of the signal passed from one device through the connector to the second device is maintained.

Because of the demand for smaller, lower weight communications equipment, it is desirable that connectors be made smaller and lower in weight, while providing the same performance characteristics. Ground contacts take up valuable space within the connector that could otherwise be used to provide additional signal contacts, and thus limit contact density (and, therefore, connector size). Additionally, manufacturing and inserting such ground contacts may increase the overall costs associated with manufacturing such connectors.

Consequently, there is a need for a high-speed electrical connector (operating above 1 Gb/s and typically in the range of about 10-20 Gb/s) that is devoid of ground contacts in the electrical connector to help increase density.

### SUMMARY OF THE INVENTION

The invention provides high speed electrical connectors (operating above 1 Gb/s and typically in the range of about 10-20 Gb/s) wherein signal contacts are arranged so as to limit the level of cross talk between adjacent differential signal pairs. The connector can be, and preferably is, devoid of ground contacts within the contact arrangement of the electrical connector. The contacts may be dimensioned and arranged relative to one another such that a differential signal in a first signal pair produces a high field in a gap between the contacts that form the signal pair, and a low field near adjacent signal pairs. Air may be used as a primary dielectric to insulate the contacts and thereby provide a low-weight high speed electrical connector.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings, and wherein:

FIG. 1A is a schematic illustration of an electrical connector in the prior art in which conductive and dielectric elements are arranged in a generally “I” shaped geometry;

FIG. 1B depicts equipotential regions within an arrangement of signal and ground contacts;

FIG. 2A is a diagrammatic view of a typical arrangement of ground and signal contacts in an electrical connector;

FIG. 2B is a diagrammatic view of another typical arrangement of ground and signal contacts in an electrical connector;

FIG. 3A illustrates a differential signal pair of an electrical connector having a ground that is adjacent to the differential signal pair;

FIG. 3B illustrates a differential signal pair of an electrical connector not having a ground that is adjacent to the differential signal pair;

FIGS. 4A and 4B are graphs illustrating impedance test results as performed on differential signal pairs of FIGS. 3A and 3B respectively;

FIGS. 5A and 5B show eye pattern test results of the differential signal pairs of FIGS. 3A and 3B, respectively;

FIGS. 6A and 6B are tables showing eye pattern test results of the differential signal pairs of FIGS. 3A and 3B, respectively;

FIG. 7 illustrates an arrangement of signal contacts within an electrical connector according to the present invention;

FIG. 8 illustrates another arrangement of signal contacts within an electrical connector according to the present invention;

FIG. 9 is a perspective view of an exemplary mezzanine-style electrical connector having a header portion and a receptacle portion in accordance with an embodiment of the invention;

FIG. 10 is a perspective view of a header insert molded lead assembly pair in accordance with an embodiment of the invention;

FIG. 11 is a perspective view of a receptacle insert molded lead assembly pair in accordance with an embodiment of the invention;

FIG. 12 is a perspective view of an operatively connected header and receptacle insert molded lead assembly pair in accordance with an embodiment of the invention.

### DETAILED DESCRIPTION OF ILLUSTRATIVE EMBODIMENTS

Certain terminology may be used in the following description for convenience only and should not be considered as limiting the invention in any way. For example, the terms “top,” “bottom,” “left,” “right,” “upper,” and “lower” designate directions in the figures to which reference is made. Likewise, the terms “inwardly” and “outwardly” designate directions toward and away from, respectively, the geometric center of the referenced object. The terminology includes the words above specifically mentioned, derivatives thereof, and words of similar import.

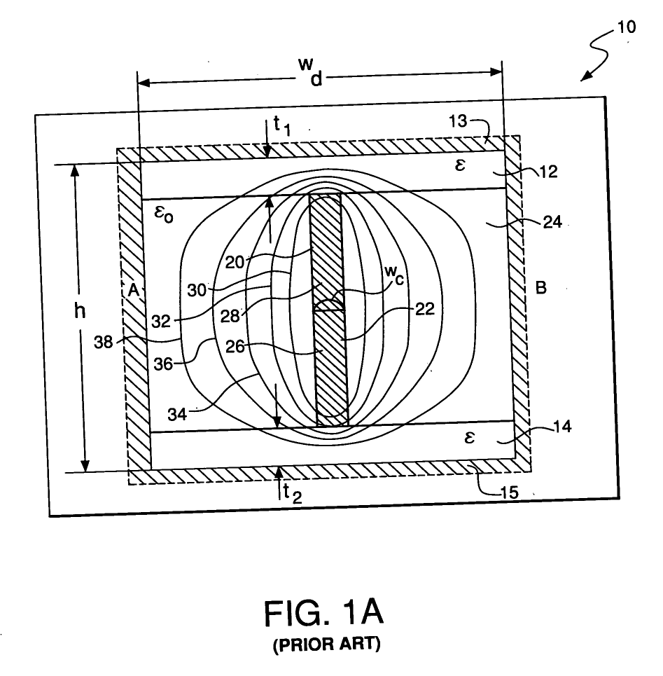

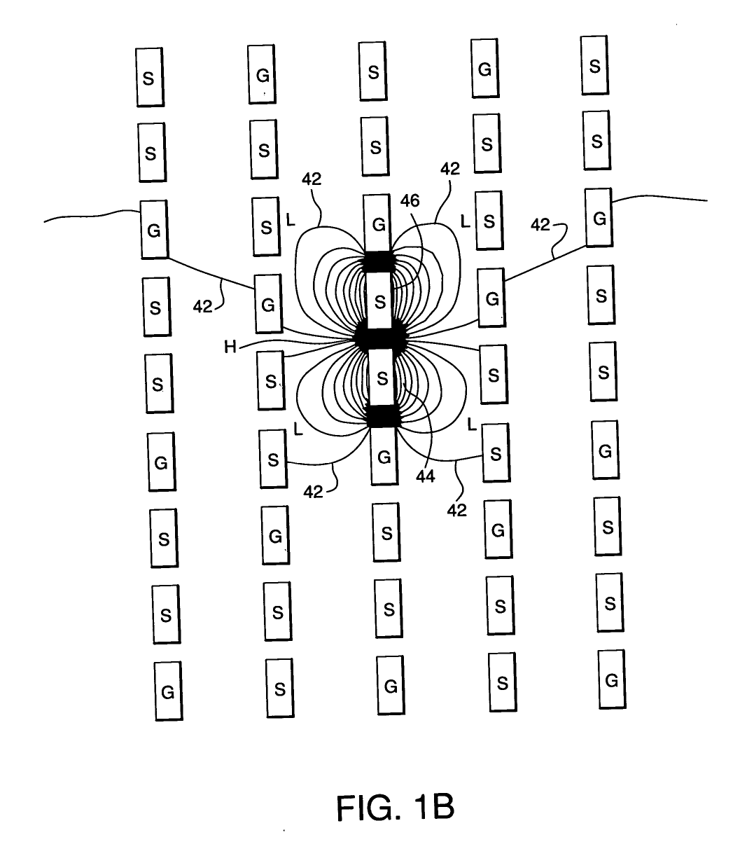

FIG. 1A is a schematic illustration of an electrical connector in which conductive and dielectric elements are arranged in a generally “I” shaped geometry. Such connectors are embodied in the assignee's “I-BEAM” technology, and are described and claimed in U.S. Pat. No. 5,741,144, entitled “Low Cross And Impedance Controlled Electric Connector,” the disclosure of which is hereby incorporated herein by reference in its entirety. Low cross talk and controlled impedance have been found to result from the use of this geometry.

The originally contemplated I-shaped transmission line geometry is shown in FIG. 1A. As shown, the conductive element can be perpendicularly interposed between two parallel dielectric and ground plane elements. The description of this transmission line geometry as I-shaped comes from the vertical arrangement of the signal conductor shown generally at numeral 10 between the two horizontal dielectric layers 12 and 14 having a permitivity ε and ground planes 13 and 15 symmetrically placed at the top and bottom edges of the conductor. The sides 20 and 22 of the conductor are open to the air 24 having an air permitivity ε₀. In a connector application, the conductor could include two sections, 26 and 28, that abut end-to-end or face-to-face. The thickness, t₁ and t₂ of the dielectric layers 12 and 14, to first order, controls the characteristic impedance of the transmission line and the ratio of the overall height h to dielectric width w_{d} controls the electric and magnetic field penetration to an adjacent contact. Original experimentation led to the conclusion that the ratio h/w_{d} needed to minimize interference beyond A and B would be approximately unity (as illustrated in FIG. 1A).

The lines 30, 32, 34, 36 and 38 in FIG. 1A are equipotentials of voltage in the air-dielectric space. Taking an equipotential line close to one of the ground planes and following it out towards the boundaries A and B, it will be seen that both boundary A or boundary B are very close to the ground potential. This means that virtual ground surfaces exist at each of boundary A and boundary B. Therefore, if two or more I-shaped modules are placed side-by-side, a virtual ground surface exists between the modules and there will be little to no intermingling of the modules' fields. In general, the conductor width w_{c} and dielectric thicknesses t₁, t₂ should be small compared to the dielectric width w_{d} or module pitch (i.e., distance between adjacent modules).

Given the mechanical constraints on a practical connector design, it was found in actuality that the proportioning of the signal conductor (blade/beam contact) width and dielectric thicknesses could deviate somewhat from the preferred ratios and some minimal interference might exist between adjacent signal conductors. However, designs using the above-described I-shaped geometry tend to have lower cross talk than other conventional designs.

### Exemplary Factors Affecting Cross Talk Between Adjacent Contacts

In accordance with the invention, the basic principles described above were further analyzed and expanded upon and can be employed to determine how to even further limit cross talk between adjacent signal contacts, even in the absence of shields between the contacts, by determining an appropriate arrangement and geometry of the signal and ground contacts. FIG. 1B includes a contour plot of voltage in the neighborhood of an active column-based differential signal pair S+, S− in a contact arrangement of signal contacts S and ground contacts G according to the invention. As shown, contour lines 42 are closest to zero volts, contour lines 44 are closest to −1 volt, and contour lines 46 are closest to +1 volt. It has been observed that, although the voltage does not necessarily go to zero at the “quiet” differential signal pairs that are nearest to the active pair, the interference with the quiet pairs is near zero. That is, the voltage impinging on the positive-going quiet differential pair signal contact is about the same as the voltage impinging on the negative-going quiet differential pair signal contact. Consequently, the noise on the quiet pair, which is the difference in voltage between the positive- and negative-going signals, is close to zero.

Thus, as shown in FIG. 1B, the signal contacts S and ground contacts G can be scaled and positioned relative to one another such that a differential signal in a first differential signal pair produces a high field H in the gap between the contacts that form the signal pair and a low (i.e., close to ground potential) field L (close to ground potential) near an adjacent signal pair. Consequently, cross talk between adjacent signal contacts can be limited to acceptable levels for the particular application. In such connectors, the level of cross talk between adjacent signal contacts can be limited to the point that the need for (and cost of) shields between adjacent contacts is unnecessary, even in high speed, high signal integrity applications.

Through further analysis of the above-described I-shaped model, it has been found that the unity ratio of height to width is not as critical as it first seemed. It has also been found that a number of factors can affect the level of cross talk between adjacent signal contacts. A number of such factors are described in detail below, though it is anticipated that there may be others. Additionally, though it is preferred that all of these factors be considered, it should be understood that each factor may, alone, sufficiently limit cross talk for a particular application. Any or all of the following factors may be considered in determining a suitable contact arrangement for a particular connector design:

a) Less cross talk has been found to occur where adjacent contacts are edge-coupled (i.e., where the edge of one contact is adjacent to the edge of an adjacent contact) than where adjacent contacts are broad side coupled (i.e., where the broad side of one contact is adjacent to the broad side of an adjacent contact) or where the edge of one contact is adjacent to the broad side of an adjacent contact. The tighter the edge coupling, the less the coupled signal pair's electrical field will extend towards an adjacent pair and the less toward the unity height-to-width ratio of the original I-shaped theoretical model a connector application will have to approach. Edge coupling also allows for smaller gap widths between adjacent connectors, and thus facilitates the achievement of desirable impedance levels in high contact density connectors without the need for contacts that are too small to perform adequately. For example, it has been found that a gap of about 0.3-0.4 mm is adequate to provide an impedance of about 100 ohms where the contacts are edge coupled, while a gap of about 1 mm is necessary where the same contacts are broad side coupled to achieve the same impedance. Edge coupling also facilitates changing contact width, and therefore gap width, as the contact extends through dielectric regions, contact regions, etc.;

b) It has also been found that cross talk can be effectively reduced by varying the “aspect ratio,” i.e., the ratio of column pitch (i.e., the distance between adjacent columns) to the gap between adjacent contacts in a given column;

c) The “staggering” of adjacent columns relative to one another can also reduce the level of cross talk. That is, cross talk can be effectively limited where the signal contacts in a first column are offset relative to adjacent signal contacts in an adjacent column. The amount of offset may be, for example, a full row pitch (i.e., distance between adjacent rows), half a row pitch, or any other distance that results in acceptably low levels of cross talk for a particular connector design. It has been found that the optimal offset depends on a number of factors, such as column pitch, row pitch, the shape of the terminals, and the dielectric constant(s) of the insulating material(s) around the terminals, for example. It has also been found that the optimal offset is not necessarily “on pitch,” as was often thought. That is, the optimal offset may be anywhere along a continuum, and is not limited to whole fractions of a row pitch (e.g., full or half row pitches).

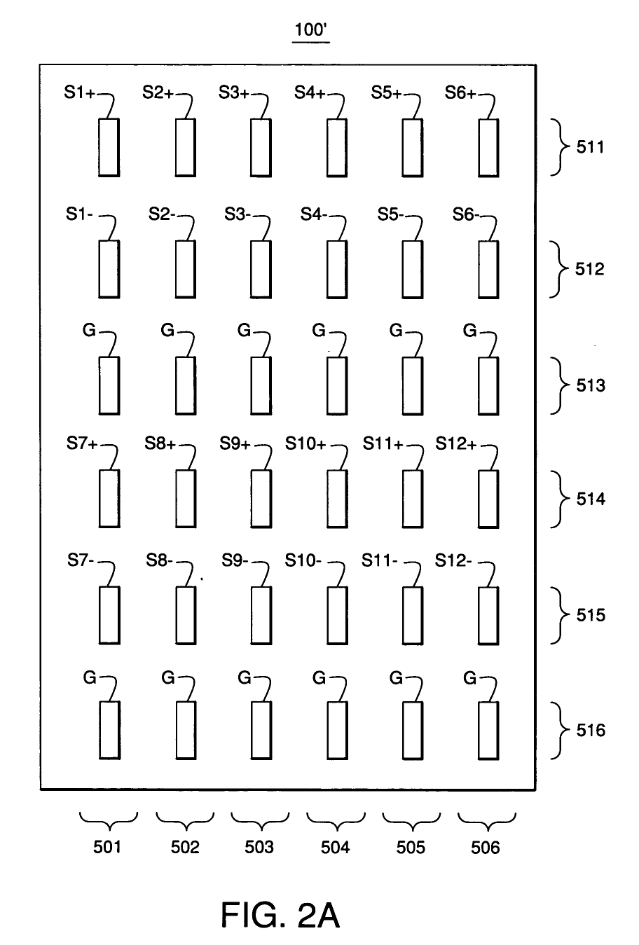

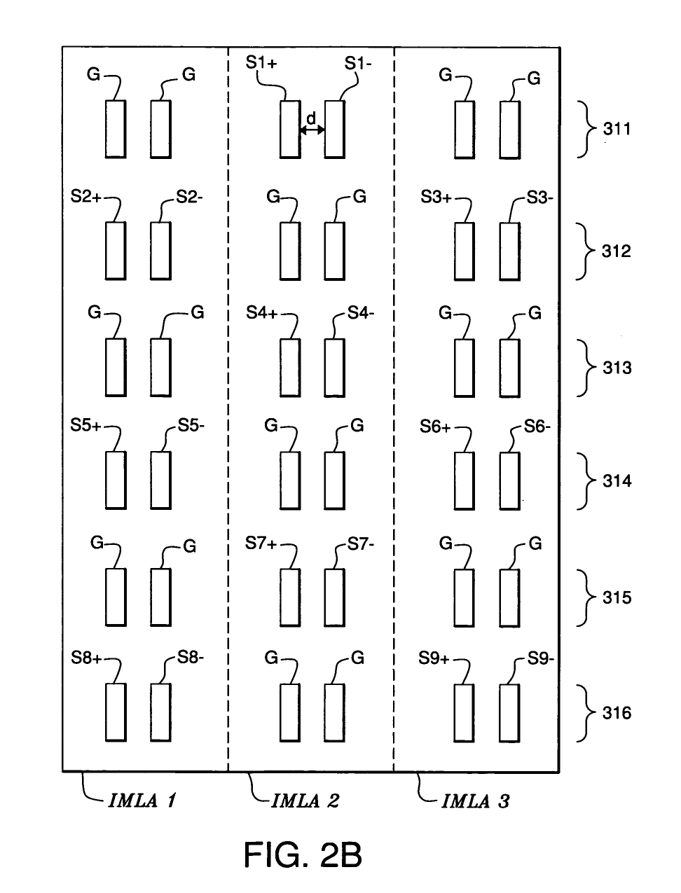

FIG. 2A is a diagrammatic view of a typical arrangement of ground and signal contacts in an electrical connector. FIG. 2A is a side diagrammatic view of conductors of a connector 100′, in which conductors are arranged in columns. As shown in FIG. 2A, each column 501-506 comprises, in order from top to bottom, a first differential signal pair, a first ground conductor, a second differential signal pair, and a second ground conductor. It should be appreciated that such an arrangement is commonly referred to as an edge coupled arrangement.

As can be seen, first column 501 comprises, in order from top to bottom, a first differential signal pair S1 (comprising signal conductors S1+ and S1−), a first ground conductor G, a second differential signal pair S7 (comprising signal conductors S7+ and S7−), and a second ground conductor G. Rows 513 and 516 comprise all ground conductors. Rows 511-512 comprise differential signal pairs S1 through S6 and rows 514-515 comprise differential signal pairs S7 through S12. As can be seen, arrangement into columns provides twelve differential signal pairs. Further, because there are no specialized ground contacts in the system, all of the interconnects are desirably substantially identical.

Alternatively, conductors 130 may be arranged in rows. FIG. 2B depicts a conductor arrangement in which signal pairs and ground contacts are arranged in rows. As shown in FIG. 2B, each row 311-316 comprises a repeating sequence of two ground contacts and a differential signal pair. In this manner, it should be appreciated that FIG. 2B depicts an arrangement of broad-sided coupled contacts. Row 311, for example, comprises, in order from left to right, two ground contacts G, a differential signal pair S1+, S1−, and two ground contacts G. Row 312, for example, comprises, in order from left to right, a differential signal pair S2+, S2−, two ground contacts G, and a differential signal pair S3+, S3−. In the embodiment shown in FIG. 2B, it can be seen that the columns of contacts can be arranged as insert molded leadframe assemblies (“IMLAs”), such as IMLAs 1-3. The ground contacts may serve to block cross talk between adjacent signal pairs. However, the ground contacts take up valuable space within the connector. As can be seen, the embodiment shown in FIG. 2B is limited to only nine differential signal pairs for an arrangement of 36 contacts because of the presence of the ground contacts.

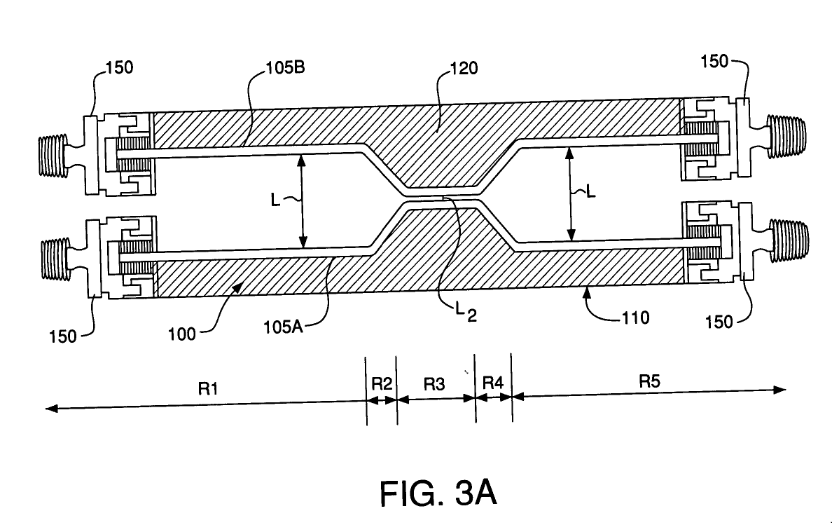

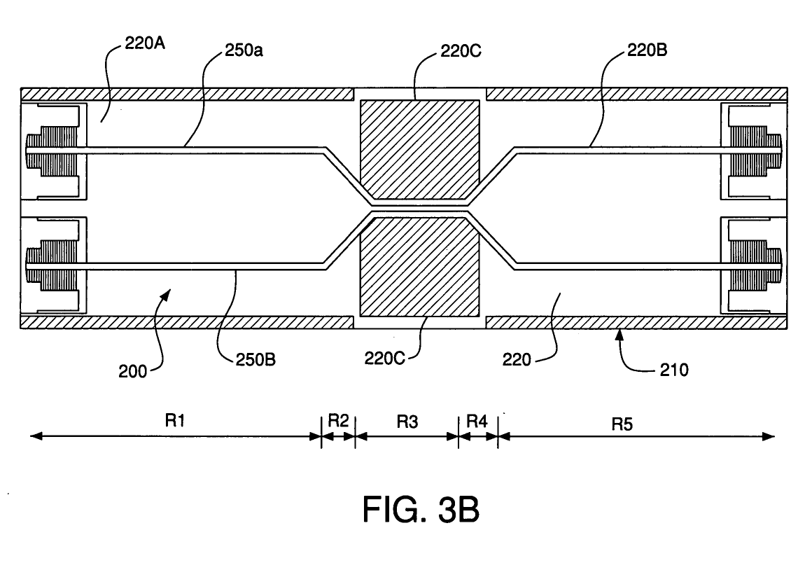

FIG. 3A illustrates a differential signal pair of an electrical connector having a ground that is adjacent the signal pair in an electrical connector. Particularly, FIG. 3A shows a printed circuit board 110 having a differential signal pair 100 disposed thereon. Differential signal pair 100 comprises two signal contacts 105A and 105B, and is adjacent to a ground plane 120. As illustrated, the ground plane 120 is adjacent to signal contacts 105A and 105B and is adapted to connect the ground references of near-end and far-end electrical devices (not shown).

For description purposes, the board 110 may be divided into five regions R1-R5. In the first region, R1, respective SMA connectors 150 with threaded mounts connected thereto are attached to the respective ends of the signal contacts 105A and 105B. The SMA connectors in region R1 are used to electrically connect a signal generator (not shown) to the signal pair 100 such that a differential signal can be driven through the signal pair 100. In region R1, the two signal contacts 105A and 105B are separated by a distance L, with both contacts being adjacent to the ground plane 120. In region R1, the ground plane 120 helps to maintain the signal integrity of the signal passing through signal contacts 105A and 105B.

In the second region, R2, the signal contacts 105A and 105B jog together until they are separated by a distance L2. In region R3, the signal contacts 105A and 105B are positioned to simulate a differential pair of signal contacts as such contacts might be positioned relative to one another in a high-density, high-speed electrical connector.

In the fourth region, R4, the signal contacts 105A and 105B jog apart until separated by a distance L. In region R5, the two signal contacts 105A and 105B are separated by a distance L, with both contacts 105A and 105B being adjacent to the ground plane 120. Also in region R5, respective SMA connectors 150 having threaded mounts connected thereto are attached to respective ends of the signal contacts 105A and 105B. The SMA connectors in region R5 are used to electrically connect the signal contacts 105A and 105B to a signal receiver (not shown) that receives the electrical signals passed through the signal pair 100.

FIG. 3B illustrates a differential signal pair of an electrical connector devoid of a ground that is adjacent to the differential signal pair. FIG. 3B shows a printed circuit board 210 having a differential signal pair 200 thereon. Differential signal pair 200 comprises two signal contacts 250A and 250B.

Like board 110, for description purposes, board 210 may be divided into five regions R1-R5. Though not shown in FIG. 3A, respective SMA connectors were attached for test purposes to the ends of the signal contacts 250A and 250B in the first region, R1. The SMA connectors (not shown) are used to electrically connect a signal generator (not shown) to the signal pair 200 such that a differential signal can be driven through signal pair 200. In region R1, the two signal contacts 250A and 250B are separated by a distance L, with both contacts being adjacent to the ground plane 220A. In region R1, the ground plane 220A helps to maintain the signal integrity of the signal passing through signal contacts 250A and 250B.

In the second region, R2, the signal contacts 250A and 250B jog together until they are separated by a distance L2. In region R3, the signal contacts 250A and 250B are positioned to simulate a differential pair of signal contacts as such contacts might be positioned relative to one another in a high-density, high-speed electrical connector.

In the fourth region, R4, the signal contacts 250A and 250B jog apart until separated by a distance L. In region R5, the two signal contacts 250A and 250B are separated by a distance L, with both contacts 250A and 250B being adjacent to the ground plane 220B. Also in region R5, respective SMA connectors (not shown) having threaded mounts connected thereto are attached to respective ends of the signal contacts 250A and 250B. The SMA connectors in region R5 are used to electrically connect the signal contacts 250A and 250B to a signal receiver (not shown) that receives the electrical signals passed through the signal pair 200.

The printed circuit board 210 contains a ground plane 220. The ground plane 220 is illustrated as the darker region on the printed circuit board 210. The ground plane 220 comprises three portions 220A, 220B, and 220C. In portions 220A and 220B, the ground plane is adjacent to the signal contacts 250A and 250B in regions R1-R2 and R4-R5. However, unlike board 110, board 210 lacks a ground plane in region R3. Consequently, board 210 was designed to simulate a connector that was devoid of a ground in the contact arrangement of an electrical connector. In other words, the design of board 210, which lacked a ground adjacent to signal contacts 250A and 250B in region R3, was designed to simulate a high speed electrical connector that lacked a ground contact adjacent to the pair of signal contacts 250A and 250B.

As shown in FIG. 3B, ground plane portion 220C connects ground plane portions 220A and 220B. In this manner, though not adjacent to signal contacts 250A and 250B in region R3, the ground plane 220 may simulate a connector that contains a ground connection that was adapted to connect the ground reference of one electrical device connected to one end of the connector to the ground reference of another electrical device connected to the other end of the connector.

The electrical connectors depicted in FIGS. 3A and 3B were subject to a number of tests to determine whether the removal of ground adjacent to the signal contacts affected the signal integrity of a high-speed signal passing through the differential signal pair. In other words, a high-speed electrical connector that was devoid of a ground contact between linear arrays of signal contacts in an electrical connector was tested to see whether the connector was suitable for impedance-controlled, high-speed, low-interference communications. Prior to testing, it was believed that the removal of a ground contact in the contact arrangement of a connector would render the connector unsuitable for impedance-controlled, high-speed, low-interference communications.

For testing purposes, a test signal was generated in a signal generator (not shown) that was connected to the end of each of the signal contacts in region R1 of boards 110, 210. A signal receiver (not shown) was attached to the other end of signal contacts in region R5 of boards 110, 210. A test signal was then driven through boards 110, 210 to determine whether the signal receiver received the generated signal without significant loss.

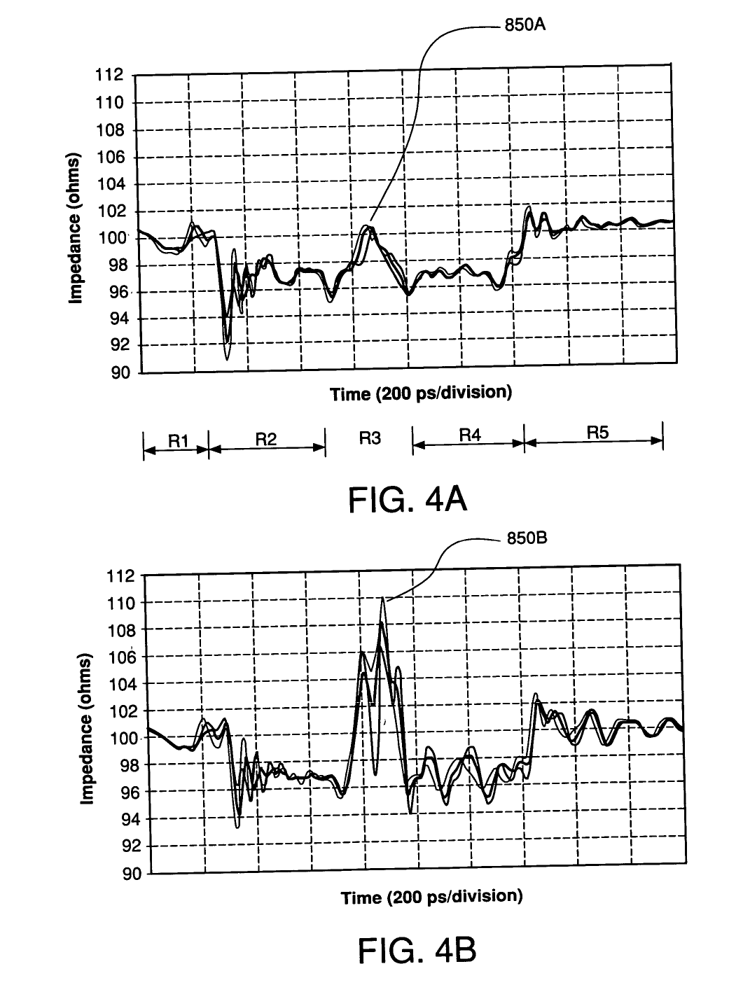

Impedance tests were one such test performed on the differential signal pairs of FIGS. 3A and 3B. Specifically, impedance tests were conducted to determine whether the removal of a ground adjacent to the signal contacts of the connector adversely affected the impedance. FIGS. 4A-B illustrate various differential impedance test results as performed on the differential signal pairs of FIGS. 3A and 3B. As shown, impedance, illustrated along the y-axis, was measured for each differential signal pair with respect to time, illustrated along the x-axis. Also as shown, the impedance of each signal pair was measured with vary degrees of skew introduced. Specifically, skews of 0-20 ps was introduced and the impedance of each pair was measured. It should be appreciated that as the data points in the graphs move from left to right along the x-axis (time), the data points depict the impedance of the signal pair as the signal moves sequentially through regions R1-R5 of the tested boards.

The differential impedance test results for the differential signal pair 100 is represented in graph FIG. 4A. As stated above, differential signal pair 100 contains a ground adjacent to the signal pair. As shown, when the test signal was passed through board 110, the differential impedance, regardless of the amount of introduced skew, remained between about 90.5 ohms and 102 ohms. It should be appreciated that in FIG. 4A the impedance of differential signal pair 100 remained within the industry standard deviation of 10%.

FIG. 4B illustrates the measured impedance of differential signal pair 200 after introducing various degrees of skew. Specifically, skews of 0-20 ps were introduced and the impedance of differential signal pair 200 was measured at each level of introduced skew. As stated above, differential signal pair 200 is devoid of a ground adjacent to the signal pair. As shown in FIG. 4B, the differential impedance of the board 210, regardless of the amount of introduced skew, remained between 93.5 ohms and 110 ohms. It should be appreciated that at all times the impedance of differential signal pair 200 remained within the industry standard deviation of 10%.

By comparison of the plots provided in FIGS. 4A and 4B, it may be understood that, even without any ground adjacent to the differential signal pair in the connector, the differential impedance between the connectors that form the signal pair remained within accepted industry standards.

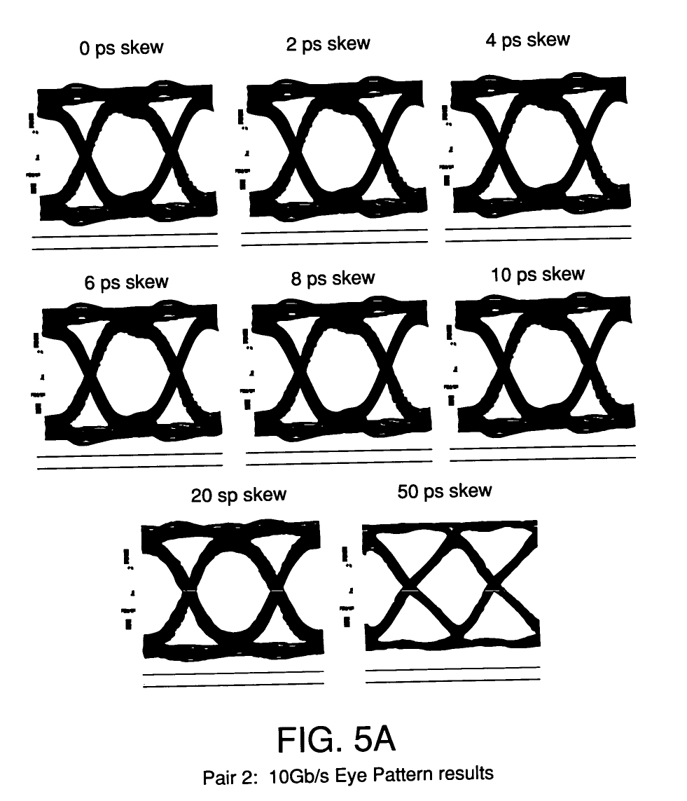

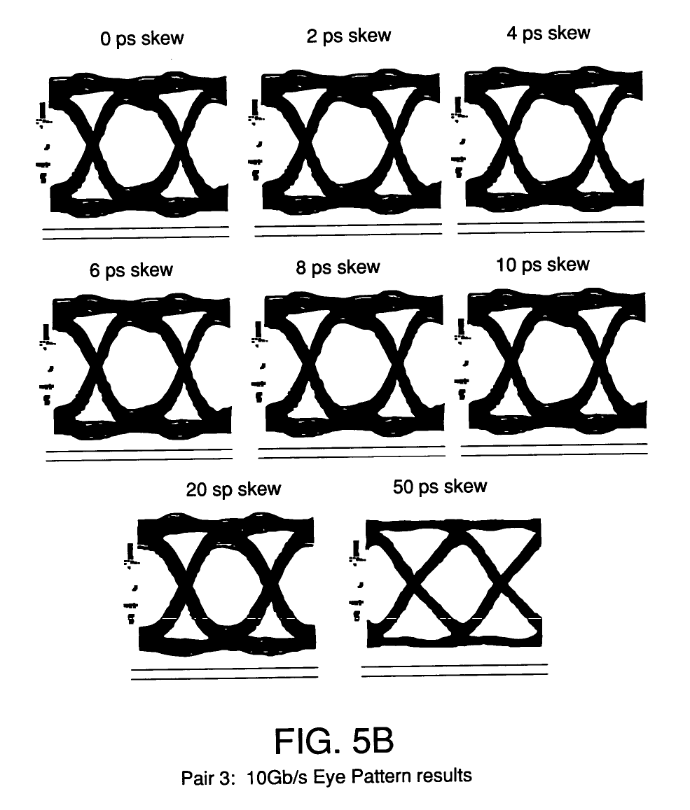

FIGS. 5A and 5B show the results of the eye pattern testing performed on the differential pairs in FIGS. 3A and 3B. Eye pattern testing is used to measure signal integrity as a result of various causes of signal degradation including, for example, reflection, radiation, cross talk, loss, attenuation, and jitter. Specifically, in eye pattern testing, sequential square wave signals are sent through a transmission path from a transmitter to a receiver. In the present case, sequential square waves were sent through the signal contacts of boards 110, 210. In a perfect transmission path (one with no loss), the received signal will be an exact replica of the transmitted square wave. However, because loss is inevitable, loss causes the square wave to morph into an image that is similar to a human eye, hence the term eye pattern testing. Specifically, the corners of the square wave become rounder and less like a right angle.

In terms of signal integrity, a signal has better integrity as the eye pattern becomes wider and taller. As the signal suffers from loss or attenuation, the vertical height of the eye becomes shorter. As the signal suffers from jitter caused for example by skew, the horizontal width of the eye becomes less. The height and width of the eye may be measured by building a mask in the interior of the eye. A mask may be a rectangle having its four corners tangent to the created eye pattern. The dimensions of the mask can then be calculated to determine the signal integrity of the transmitted signal.

As illustrated in FIG. 5A, eye pattern testing was performed at 6.25 Gb/s on the differential signal pair 100 of FIG. 3A with introduced skew of 0 ps, 2 ps, 4 ps, 6 ps, 8 ps, 10 ps, 20 ps, 50 ps, and 100 ps. Prior to testing, it was believed that a differential signal pair having an adjacent ground on printed circuit board 110 (or a high speed connector) and introducing various levels of skew with a test signal of 6.25 Gb/s, the resulting eye pattern would be acceptable and such signal transmission configuration suitable for use in a high speed electrical connector. As shown in FIG. 5A, as expected, the eye pattern test results are considered commercially acceptable for certain applications.

As illustrated in FIG. 5B, eye pattern testing was performed at 6.25 Gb/s on the differential signal pair 200 of FIG. 3B with introduced skew of 0 ps, 2 ps, 4 ps, 6 ps, 8 ps, 10 ps, 20 ps, 50 ps, and 100 ps. Prior to testing, it was believed that by removing the ground adjacent to the signal pair 200 on printed circuit board 210 (or a high speed connector) and introducing various levels of skew with a test signal of 6.25 Gb/s, the resulting eye pattern would be unacceptable and such signal transmission configuration unsuitable for use in a high speed electrical connector. As shown in FIG. 5B, the eye pattern test results are considered commercially acceptable for certain applications.

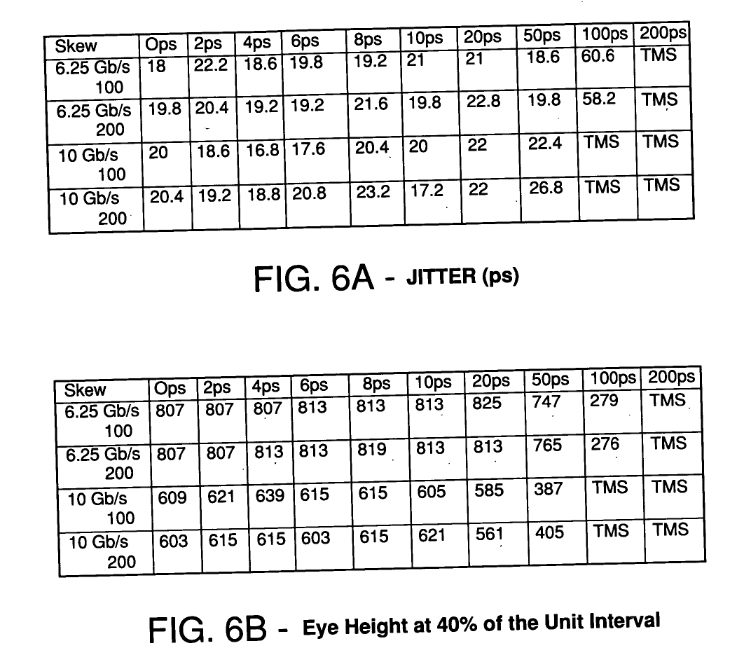

FIGS. 6A and 6B are tables that quantitatively show the results of the eye pattern testing as performed on differential signal pair 100 and 200. FIG. 6A shows jitter measurements from signal pairs 100 and 200 when test signals of 6.25 Gb/s and 10 Gb/s were passed therethrough. Jitter is determined by measuring the horizontal dimension of the mask in the eye pattern. As shown in FIG. 6A, when 200 ps of skew was introduced in signal pairs 100 and 200 at 6.25 Gb/s, the resulting jitter could not be measured. In other words, too much skew rendered the eye pattern unreadable. Also, when 100 ps and 200 ps of skew was introduced in signal pairs 100 and 200 at 10 Gb/s, the resulting jitter could not be measured because of too much skew.

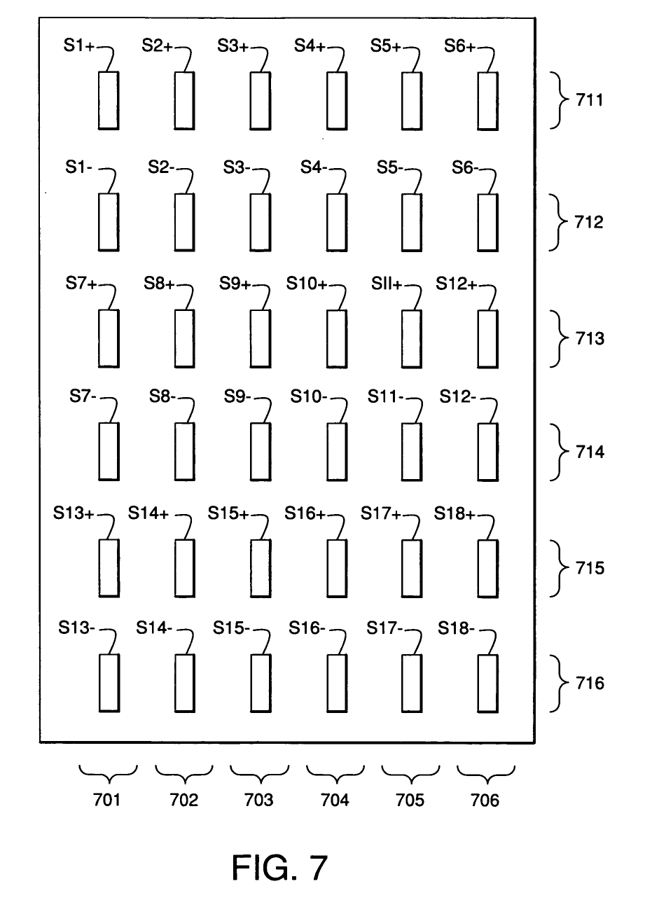

FIG. 6B shows the eye height taken at 40% of the unit interval of the signal pairs 100 and 200 when test signals of 6.25 Gb/s and 10 Gb/s were passed therethrough. As shown in FIG. 7B, when 200 ps of skew was introduced in pairs 100 and 200 at 6.25 Gb/s, the eye height and jitter could not be measured because of too much skew. Also, when 100 ps and 200 ps of skew was introduced in pairs 100 and 200 at 10 Gb/s, the eye height could not be measured because of too much skew.

FIG. 7 illustrates an arrangement of signal contacts within an electrical connector according to the present invention. In particular, FIG. 7 shows a plurality of differential signal pairs arranged in columns. As shown in FIG. 7, each column 701-706 comprises, in order from top to bottom, a first differential signal pair, a second differential signal pair, and a third differential signal pair. It should be appreciated that such an arrangement is commonly referred to as an edge coupled arrangement.

As can be seen, first column 701 comprises, in order from top to bottom, a first differential signal pair S1 (comprising signal conductors S1+ and S1−), a second differential signal pair S7 (comprising signal conductors S7+ and S7−), and a third differential signal pair S13 (comprising signal conductors S13+ and S13−). Rows 711-716 comprise all differential signal pairs. As can be seen, arrangement into columns provides eighteen differential signal pairs. Unlike the arrangement discussed above in connection with FIG. 2A, no ground contacts are needed. Thus, in an embodiment of the invention, and as shown in FIG. 7, the connector may be devoid of ground contacts.

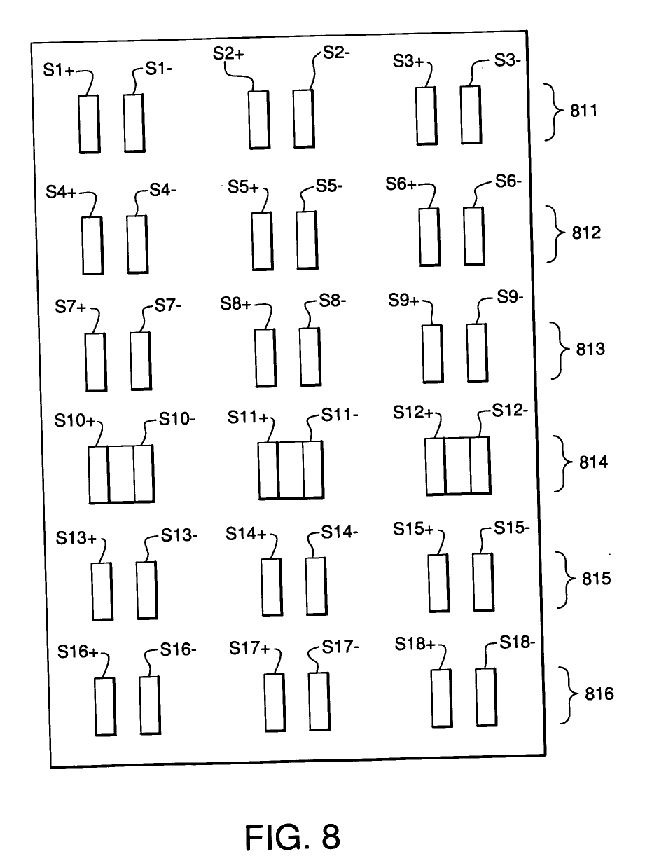

Turning now to FIG. 8, a conductor arrangement is depicted in which signal pairs are arranged in rows. In particular, FIG. 8 shows a plurality of differential signal pairs that are broad-sided coupled. As can be seen in FIG. 8, each row 811-816 comprises a plurality of differential signal pairs. First row 811 comprises, in order from left to right, three differential signal pairs: S1+ and S1−, S2+ and S2−, and S3+ and S3−. Each additional row in the exemplary arrangement of FIG. 8 contains three differential signal pairs. Unlike the arrangement discussed above in connection with FIG. 2B, no ground contacts are needed. Thus, in an embodiment of the invention, and as shown in FIG. 8, the connector may be devoid of ground contacts.

As can be seen, therefore, the embodiment shown in FIG. 8 provides 18 differential signal pairs for an arrangement of 36 contacts, which is a significant improvement over the nine differential signal pairs in the arrangement depicted above in FIG. 2B. Thus, a connector according to the invention may be lighter and smaller for a given number of differential signal pairs, or have a greater concentration of differential signal pairs for a given weight and/or size of the connectors. It should be understood that an embodiment of the invention may encompass any number of conductor arrangements. For example, another conductor arrangement according to the invention could have offset adjacent columns of broadside-coupled pairs.

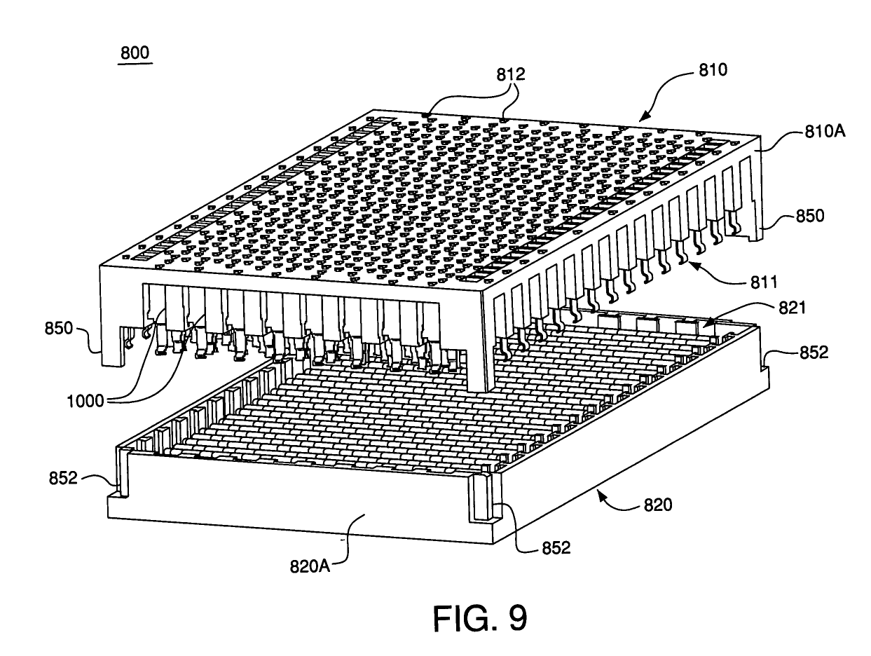

FIG. 9 depicts a typical mezzanine-style connector assembly. It will be appreciated that a mezzanine connector is a high-density stacking connector used for parallel connection of one electrical device such as, a printed circuit board, to another electrical device, such as another printed circuit board or the like. The mezzanine connector assembly 800 illustrated in FIG. 9 comprises a receptacle 810 and header 820.

In this manner, an electrical device may electrically mate with receptacle portion 810 via apertures 812. Another electrical device may electrically mate with header portion 820 via ball contacts. Consequently, once header portion 820 and receptacle portion 810 of connector 800 are electrically mated, the two electrical devices that are connected to the header and receptacle are also electrically mated via mezzanine connector 800. It should be appreciated that the electrical devices can mate with the connector 800 in any number of ways without departing from the principles of the present invention.

Receptacle 810 may include a receptacle housing 810A and a plurality of receptacle grounds 811 arranged around the perimeter of the receptacle housing 810A, and header 820 may include a header housing 820A and a plurality of header grounds 821 arranged around the perimeter of the header housing 820A. The receptacle housing 810A and the header housing 820A may be made of any commercially suitable insulating material. The header grounds 821 and the receptacle grounds 811 serve to connect the ground reference of an electrical device that is connected to the header 820 to the ground reference of an electrical device that is connected to the receptacle 810. The header 820 can also contains header IMLAs (not individually labeled in FIG. 9 for clarity) and the receptacle 810 can contains receptacle IMLAs 1000.

The receptacle connector 810 may contain one or more alignment pins 850. Alignment pins 850 mate with alignment sockets 852 found in the header 820. The alignment pins 820 and alignment sockets 852 serve to align the header 820 and the receptacle 810 during mating. Further, the alignment pins 820 and alignment sockets 852 serve to reduce any lateral movement that may occur once the header 820 and receptacle 810 are mated. It should be appreciated that numerous ways to connect the header portion 820 and receptacle portion 810 may be used without departing from the principles of the invention.

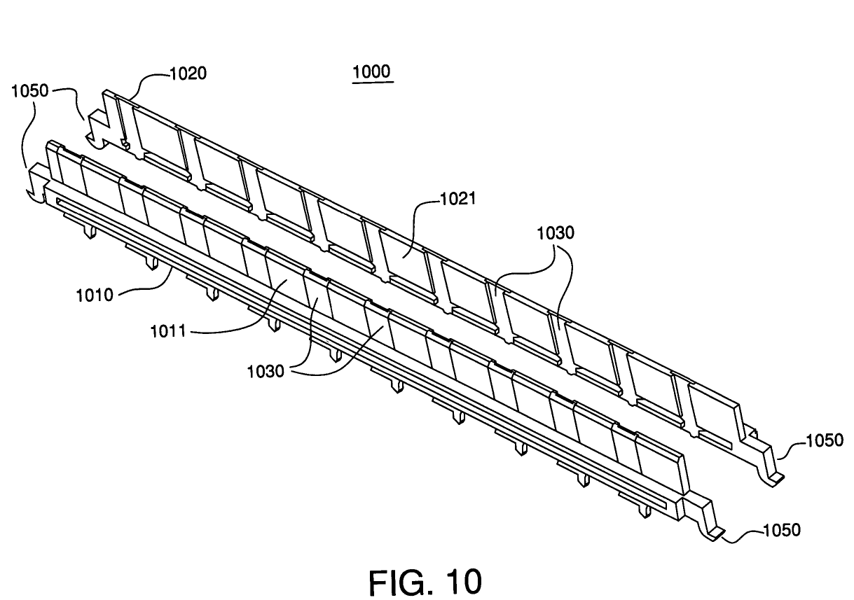

FIG. 10 is a perspective view of a header insert molded lead assembly pair that may be used in a high speed connector in accordance with an embodiment of the invention. In FIG. 10, the header IMLA pair 1000 comprises a header IMLA A 1010 and a header IMLA B 1020. IMLA A 1010 comprises an overmolded housing 1011 and a series of header contacts 1030, and header IMLA B 1020 comprises an overmolded housing 1021 and a series of header contacts 1030. As can be seen in FIG. 10, the header contacts 1030 are recessed into the housings of header UMLAs 1010 and B 1020. It should be appreciated that header IMLA pair 1000 may contain only signal contacts with no ground contacts or connections contained therein.

IMLA housing 1011 and 1021 may also include a latched tail 1050. Latched tail 1050 may be used to securely connect IMLA housing 1011 and 1021 in header portion 820 of mezzanine connector 800. It should be appreciated that any method of securing the IMLA pairs to the header 820 may be employed.

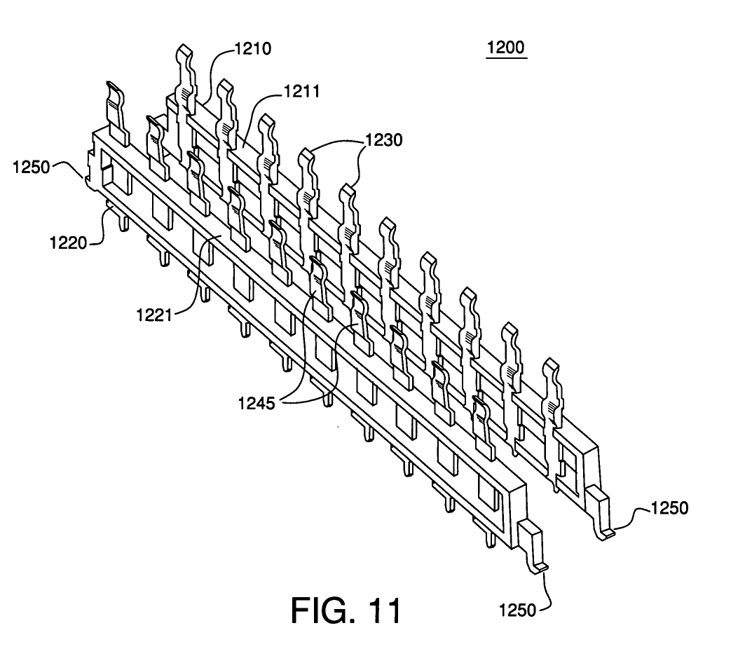

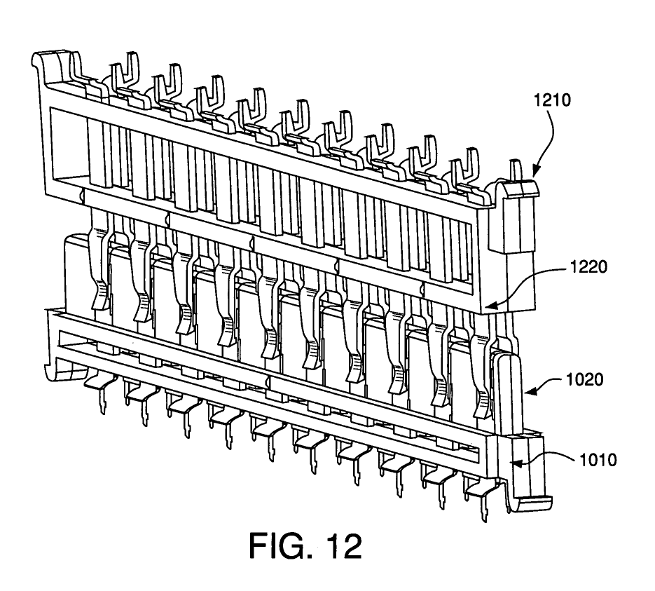

FIG. 11 is a perspective view of a receptacle insert molded lead assembly pair in accordance with an embodiment of the invention. Receptacle IMLA pair 1200 comprises receptacle IMLA A 1210 and receptacle IMLA B 1220. Receptacle IMLA A 1210 comprises an overmolded housing 1211 and a series of receptacle contacts 1230, and a receptacle IMLA B 1220 comprises an overmolded housing 1221 and a series of receptacle contacts 1240. As can be seen in FIG. 12, the receptacle contacts 1240, 1230 are recessed into the housings of receptacle IMLAs 1210 and B 1220. It will be appreciated that fabrication techniques permit the recesses in each portion of the IMLA 1210, 1220 to be sized very precisely. In accordance with one embodiment of the invention, the receptacle IMLA pair 1200 maybe devoid of any ground contacts.

IMLA housing 1211 and 1221 may also include a latched tail 1250. Latched tail 1250 may be used to securely connect IMLA housing 1211 and 1221 in receptacle portion 910 of connector 900. It should be appreciated that any method of securing the IMLA pairs to the header 920 may be employed.

FIG. 12 is a perspective view of a header and receptacle IMLA pair in accordance with an embodiment of the invention. In FIG. 12, a header and receptacle IMLA pair are in operative communications in accordance with an embodiment of the present invention. In FIG. 12, it can be seen that header IMLAs 1010 and 1020 are operatively coupled to form a single and complete header IMLA. Likewise, receptacle IMLAs 1210 and B 1220 are operatively coupled to form a single and complete receptacle IMLA. FIG. 12 illustrates an interference fit between the contacts of the receptacle IMLA and the contacts of the header IMLA, it will be appreciated that any method of causing electrical contact, and/or for operatively coupling the header IMLA to the receptacle IMLA, is equally consistent with an embodiment of the present invention.

It is to be understood that the foregoing illustrative embodiments have been provided merely for the purpose of explanation and are in no way to be construed as limiting of the invention. Words which have been used herein are words of description and illustration, rather than words of limitation. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

1. An electrical connector comprising:
a connector housing that defines a cavity; and
a first signal contact disposed within the cavity of the connector housing,
wherein the electrical connector is devoid of any ground contact adjacent to the signal contact.

2. The electrical connector of claim 1, further comprising a second signal contact adjacent to the first signal contact, wherein the first and second signal contacts form a differential signal pair.

3. The electrical connector of claim 2, wherein the wherein the electrical connector is devoid of any ground contact adjacent to the second signal contact.

4. The electrical connector of claim 1, further comprising a leadframe assembly disposed within the connector housing, wherein the leadframe assembly includes a leadframe housing and wherein the signal contact extends at least partially through the leadframe housing.

5. The electrical connector of claim 4, wherein the leadframe housing is overmolded onto the signal contact.

6. The electrical connector of claim 1, wherein the connector housing is filled at least in part with a dielectric material that insulates the contacts.

7. The electrical connector of claim 6, wherein the dielectric material is air.

8. An electrical connector comprising:
a first plurality of signal contacts arranged in a first linear array;
a second plurality of signal contacts arranged in a second linear array that is adjacent to the first linear array;
wherein the electrical connector is devoid of any ground contact adjacent to the first linear array and is further devoid of any ground contact adjacent to the second array.

9. The electrical connector of claim 8, further comprising a leadframe assembly disposed within the connector housing, wherein the leadframe assembly includes a leadframe housing and wherein the first plurality of signal contacts extends at least partially through the leadframe housing.

10. The electrical connector of claim 9, wherein the leadframe housing is overmolded onto the signal contact.

11. The electrical connector of claim 9, wherein the leadframe assembly is devoid of any ground contact.

12. An electrical connector comprising:
a connector housing; and
a signal contact disposed within the connector housing,
wherein the electrical connector is devoid of any ground contacts within the connector housing.

13. The electrical connector of claim 12, wherein the electrical connector is adapted to electrically connect a first electrical device having a first ground reference to a second electrical device having a second ground reference, further comprising:
a ground connection disposed on the perimeter of the housing, said ground connection adapted to electrically connect the first ground reference and the second ground reference.
